(19) United States
(12) Patent Application Publication
(10) Pub. No.: US 2010/0266785 A1
(43) Pub. Date: Oct. 21, 2010

(54) INTERMEDIATE TRANSFER MEMBER, METHOD FOR MANUFACTURING INTERMEDIATE TRANSFER MEMBER AND IMAGE-FORMING APPARATUS

(75) Inventors: Yasuo Kurachi, Itabashi-ku (JP); Hiroshi Tanaka, Hachioji-shi (JP); Masahiko Adachi, Tondabayashi-shi (JP); Kouji Nishimura, Toyokawa-shi (JP); Toshio Tsukamoto, Hino-shi (JP); Katsumi Furusawa, Toyokawa-shi (JP); Yoshiyuki Mizumo, Kaizuka-shi (JP); Masatoshi Yamaguchi, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/753,497

(22) Filed: Apr. 2, 2010

(30) Foreign Application Priority Data
Apr. 16, 2009 (JP) 2009-099760

(51) Int. Cl. H05H 1/24; B32B 13/12

(52) U.S. Cl. 427/569; 428/477.7; 428/451

(57) ABSTRACT

An intermediate transfer member that is provided with a base member containing polyphenylene sulfide and polyamide, and a semi-conductive inorganic layer having a volume specific resistance in the range from 1×10⁷ Ωcm to 1×10¹³ Ωcm, that is formed on the base member, a method for manufacturing such an intermediate transfer member in which the inorganic layer is formed by means a plasma CVD method, and an image-forming apparatus equipped with such an intermediate transfer member.

This application is based on application(s) No. 2009-099760 filed in Japan, the contents of which are hereby incorporated by reference.

### BACKGROUND OF THE INVENTION

1. Field of the Invention

The present invention relates to an intermediate transfer member, a method for manufacturing an intermediate transfer member and an image-forming apparatus.

2. Description of the Related Art

Conventionally, an image-forming apparatus that utilizes an electrophotographic system, such as a copying machine, a printer and a facsimile, have been known. Such an image-forming apparatus generally uses an intermediate transfer member. The intermediate transfer member has a structure in which a toner image is primarily transferred on a surface of its own from a first toner image-supporting member by a first transfer means. The toner image thus transferred is supported by the intermediate transfer member, and after having been transported, is then secondarily transferred onto a sheet of recording paper or the like by a second transfer means.

Such an intermediate transfer member has been proposed in which the surface of the intermediate transfer member is coated with a silicon oxide, an aluminum oxide or the like so that it is possible to improve the releasing characteristic of a toner image and consequently to improve the transfer efficiency onto a sheet of recording paper or the like (for example, JP-A No. 9-212004). JP-A No. 9-212004 has disclosed a method in which a metal oxide layer is formed by a vapor deposition method or a sputtering method. However, the metal oxide layer obtained by the vacuum vapor deposition method or the sputtering method has a problem that it has an extremely high electric resistance. For this reason, since electric charge is accumulated in the metal oxide layer when used, it is not possible to obtain sufficient transferring characteristic and cleaning characteristic. The vacuum vapor deposition method causes poor adhesion between the metal oxide layer formed on the base member and the base member, while the sputtering method causes problems that the generation rate of metal oxide layer is very low and that a crack tends to occur on a polymer base member.

Therefore, another method is proposed in which the metal oxide layer is formed by using a thermal CVD method or a wet coating method. However, since the thermal CVD method is a method of oxidizing and decomposing a material gas by thermal energy of the base member to form a thin film, the base member needs to be set to a high temperature so that the base member temperature of about 300 to 500° C. is required, making it difficult to form the metal oxide layer on a plastic film by using the thermal CVD method. In the case of a wet coating method by the use of a sol-gel method or the like, it becomes difficult to prepare the metal oxide layer as a thin film, to provide a uniform film quality and to control the film thickness. In general, the wet coating method makes the film fragile in comparison with those films formed by the gaseous phase method, resulting in a failure to maintain the transfer efficiency properly for a long period of time.

### BRIEF SUMMARY OF THE INVENTION

The present invention provides first an intermediate transfer member that is provided with a base member containing polyphenylene sulfide and polyamide, and a semi-conductive inorganic layer having a volume specific resistance in the range from 1×10⁷ Ωcm to 1×10¹³ Ωcm, that is formed on the base member.

The present invention also relates to a method for manufacturing an intermediate transfer member that is characterized in that an inorganic layer is formed on a base member containing polyphenylene sulfide and polyamide by using a plasma CVD method.

The present invention also relates to an image-forming apparatus characterized by installing such an intermediate transfer member as above.

### BRIEF DESCRIPTION OF THE DRAWINGS

FIG. 1 is a structural cross-sectional view that shows one example of a color image-forming apparatus.

FIG. 2 is a conceptual cross-sectional view that shows a layer structure of an intermediate transfer member.

FIG. 3 is an explanatory drawing that shows a manufacturing device for manufacturing an intermediate transfer member.

FIG. 4 is an explanatory drawing that shows a second manufacturing device for manufacturing an intermediate transfer member.

FIG. 5 is an explanatory drawing of a first manufacturing device for manufacturing an intermediate transfer member by using plasma.

FIG. 6 is an explanatory drawing of the second manufacturing device for manufacturing an intermediate transfer member by using plasma.

FIG. 7 is a schematic drawing that shows one example of a roll electrode.

FIG. 8 is a schematic drawing that shows one example of a fixed electrode.

### DETAILED DESCRIPTION OF THE INVENTION

The intermediate transfer member of the present invention is suitably used for an image-forming apparatus, such as a copying machine, a printer and a facsimile, of an electrophotographic system. The intermediate transfer member allows a toner image supported on the surface of a photosensitive member to be primarily transferred on the surface of its own, holds the transferred toner image, and secondarily transfers the toner image held thereon to the surface of an image receiving medium, such as a sheet of recording paper. The following description will explain a structure in which the intermediate transfer member of the present invention is prepared as a belt-shaped member; however, the intermediate transfer member may have a drum shape.

Image-Forming Apparatus

First, the following description will discuss an image-forming apparatus having an intermediate transfer member of the present invention, by exemplifying a tandem-type full color copying machine.

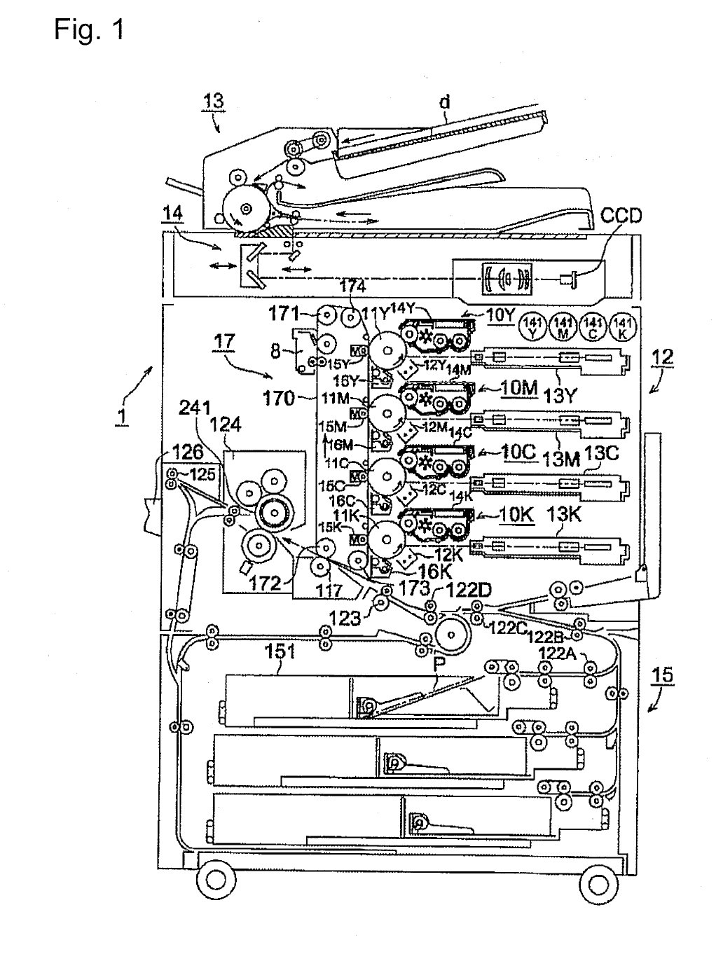

FIG. 1 is a structural cross-sectional view showing one example of a color image-forming apparatus.

This color image-forming apparatus 1, which is referred to as a tandem-type full color copying machine, is provided with an automatic document feeder 13, a document image-reading device 14, a plurality of exposing means 13Y, 13M, 13C, and 13K, a plurality of sets of image-forming units 10Y, 10M, 10C, and 10K, an intermediate transfer unit 17, a paper feeding means 15 and a fixing means 124.

On the upper portion of a main body 12 of the image-forming apparatus, the automatic document feeder 13 and the document image reading device 14 are installed, and an image of a document d transferred by the automatic document feeder 13 is reflected and formed into an image by an optical system of the document image-reading device 14 so that the resulting image is read by a line image sensor CCD.

An analog signal, formed by photoelectrically converting the document image read by the line image sensor CCD, is subjected to processes, such as an analog process, an A/D conversion, a shading correction and an image compression process, in an image-processing unit not shown, and then sent to the exposing means 13Y, 13M, 13C, and 13K as digital image data of respective colors so that latent images of the image data of respective colors are formed on the corresponding drum-shaped photosensitive members (hereinafter, referred to also as photosensitive members) serving as first image-supporting members, by the exposing means 13Y, 13M, 13C, and 13K.

The image-forming units 10Y, 10M, 10C, and 10K are longitudinally disposed in the vertical direction, and on the left side of photosensitive members 11Y, 11M, 11C, and 11K of the drawing, an intermediate transfer member (hereinafter, referred to as an “intermediate transfer belt”) 170 of the present invention having a semi-conductive property, prepared as an endless belt, which serves as a second image supporting member and is wound around rollers 171, 172, 173, and 174 to be extended over them so as to rotate thereon, is placed.

The intermediate transfer belt 170 of the present invention is driven in a direction of the arrow through a roller 171 that is driven to rotate by a driving device (not shown).

The image-forming unit 10Y for forming a yellow color image is provided with a charging means 12Y, an exposing means 13Y, a developing means 14Y, a primary transfer roller 15Y serving as a primary transfer means and a cleaning means 16Y, which are disposed on the periphery of the photosensitive member 11Y.

The image-forming unit 10M for forming a magenta color image is provided with a photosensitive member 11M, a charging means 12M, an exposing means 13M, a developing means 14M, a primary transfer roller 15M serving as a primary transfer means and a cleaning means 16M.

The image-forming unit 10C for forming a cyan color image is provided with a photosensitive member 11C, a charging means 12C, an exposing means 13C, a developing means 14C, a primary transfer roller 15C serving as a primary transfer means and a cleaning means 16C.

The image-forming unit 10K for forming a black image is provided with a photosensitive member 11K, a charging means 12K, an exposing means 13K, a developing means 14K, a primary transfer roller 15K serving as a primary transfer means and a cleaning means 16K.

Toner supply means 141Y, 141M, 141C, and 141K supply new toner to the developing devices 14Y, 14M, 14C, and 14K, respectively.

The primary transfer rollers 15Y, 15M, 15C, and 15K are selectively actuated depending on the type of an image by a control means (not shown), and respectively press the intermediate transfer belt 170 onto the corresponding photosensitive members 11Y, 11M, 11C, and 11K so that an image on the photosensitive member is transferred thereon.

In this manner, images of the respective colors formed on the photosensitive members 11Y, 11M, 11C, and 11K by the image-forming units 10Y, 10M, 10C, and 10K, are successively transferred onto the rotating intermediate transfer belt 170 by the primary transfer rollers 15Y, 15M, 15C, and 15K so that a composed color image is formed. That is, the intermediate transfer belt allows the toner images supported on the photosensitive members to be primarily transferred on its surface, and holds the transferred toner images.

Each sheet of recording paper P serving as a recording medium, housed in a paper-feed cassette 151, is fed by a paper-feeding means 15, and is then transported to a secondary transfer roller 117 serving as a secondary transfer means, through a plurality of rollers, such as intermediate rollers 122A, 122B, 122C, and 122D, and a resist roller 123, and the toner image, composed on the intermediate transfer member by the secondary transfer roller 117, is transferred onto the sheet of recording paper P at one time by the secondary transfer roller 117. That is, the toner image held on the intermediate transfer member is secondarily transferred onto the surface of the image recording medium.

The secondary transfer roller 117 brings the recording paper P into contact with the intermediate transfer belt 170 only when the recording paper P is passing through this portion so as to be subjected to a secondary transferring process.

The recording paper P bearing the color image transferred thereon is subjected to a fixing process by the fixing means 124, and is then sandwiched by paper-discharging rollers 125 and placed onto a paper discharge tray 126 outside the machine.

After the color image has been transferred onto the recording paper P by the secondary transfer roller 117, the intermediate transfer belt 170 from which the recording paper P has been curvature-separated is subjected to a residual toner-removing process by a cleaning means 8.

Intermediate Transfer Belt

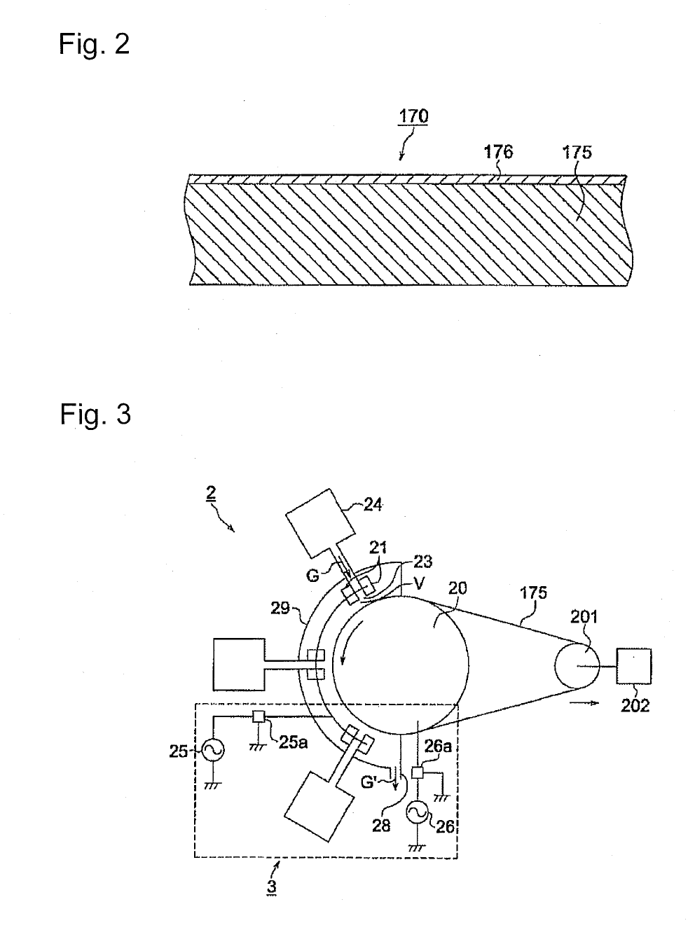

The intermediate transfer belt 170 of the present invention has a semi-conductive inorganic layer formed on a base member. FIG. 2 is a schematic cross-sectional view showing the intermediate transfer belt 170. In FIG. 2, the reference numeral 175 represents a base member, and reference numeral 176 represents a semi-conductive inorganic layer.

The base member 175 contains polyphenylene sulfide (PPS) and polyamide.

PPS is useful as a so-called engineering plastic material. Although not particularly limited, the molecular weight of PPS is preferably set in the range from 5000 to 1000000, in particular, from 40000 to 90000, in Mw of the peak molecular weight of the molecular weight distribution found by a gel permeation chromatograph method, from the viewpoint of improving the melt flowability.

The production method of PPS is not particularly limited, and for example, known methods, such as methods disclosed in JP-B No. 52-12240 and JP-A No. 61-7332, may be used.

PPS may be commercially available as polyphenylene sulfide made by Toray Industries, Inc., DIC Corporation, or the like.

PPS may be subjected to various treatments before its application within such a range that the effects of the present invention is not impaired. Those treatments include, for example, a heat treatment under an inert-gas atmosphere, such as nitrogen, or a reduced pressure, a washing treatment with hot water or the like, and an activating treatment by the use of a functional group-containing compound, such as an acid anhydride, an amine, an isocyanate, or a functional group-containing disulfide compound.

Polyamide is a polymer that is referred to also as nylon. Polyamide is not particularly limited, and various polyamides may be used. Specific examples thereof include: polyamides obtained by ring-opening polymerization of lactams, such as ε-caprolactam and ω-dodecalactam; polyamides derived from an amino acid, such as 6-aminocaproic acid, 11-aminoundecanoic acid and 12-aminododecanoic acid; polyamides derived from aliphatic, alicyclic or aromatic diamines, such as ethylene diamine, tetramethylene diamine, hexamethylene diamine, undeca methylene diamine, dodeca methylene diamine, 2,2,4-/2,4,4-trimethyl hexamethylene diamine, 1,3-and 1,4-bis(aminomethyl)cyclohexane, bis(4,4′-amino cyclohexyl)methane, and metha- and para-xylylene diamine, and acid derivatives of aliphatic, alicyclic or aromatic dicarboxylic acids, such as adipic acid, suberic acid, sebacic acid, dodecanedioic acid, 1,3-and 1,4-cyclohexane dicarboxylic acid, isophthalic acid, terephthalic acid and dimer acid, or acid halides of these (for example, acid chlorides), and copolymerized polyamides of these; and mixed polyamides of these, and the like. In the present invention, among these, normally, poly(tetramethylene adipamide) (Nylon-46), polyamide of methaxylylene diamine and adipic acid, polycaproamide (Nylon-6), polyundecane amide (Nylon-11), polydodecane amide (Nylon-12), poly(hexamethylene adipamide) (Nylon-66) and copolymerized polyamide mainly composed of these polyamide raw materials are effectively used.

The degree of polymerization of polyamides is not particularly limited, and for example, polyamides having a relative viscosity in the range from 2.0 to 5.0 (1 g of a polymer is dissolved in 100 ml of 98% concentrated sulfuric acid, and the relative viscosity is measured at 25° C.) may be desirably selected depending on purposes.

The polymerization method of polyamide is not particularly limited, and normally, known melt polymerization method, solution polymerization method and combined method of these may be used.

Moreover, polyamide may be commercially available as 6-Nylon (made by Toray Industries, Inc.), MXD6 (made by Mitsubishi Gas Chemical Company), 4,6-Nylon (made by DSM Japan Engineering Plastics), Zytel (made by E. I. DuPont de Nemours and Company), and the like.

The ratio of contents of PPS and polyamide in the base member 175 is normally set to 70/30 to 95/5 in weight ratio, and preferably set to 85/15 to 95/5 from the viewpoint of electrical conductivity of the inorganic layer.

Another polymer may be contained in the base member 175. As such a polymer, for example, resin materials and fluorine-based resins, such as a polycarbonate (PC), a polyimide (PI), a polyamideimide (PAI), a polyvinylidene fluoride (PVDF) and a tetrafluoroethylene-ethylene copolymer (ETFE), and rubber materials, such as EPDM, NBR, CR and polyurethane, may be used.

The content of another polymer in the base member 175 is preferably set to 15% by weight or less, from the viewpoint of electrical conductivity of the inorganic layer.

A conductive substance is preferably contained in the base member 175. The conductive substance is not particularly limited as long as it imparts a conductive property thereto when contained, and such a substance that exerts a volume specific resistance of 10⁵ Ω·cm or less in a powder state is preferably used. As the conductive substance, for example, known conductive substances that have been conventionally used in the field of the electrophotographic transfer belt can be used. Specific examples thereof include: carbon; metal oxide fine particles, such as tin oxide, zinc oxide, tin oxide doped with indium and tin oxide doped with antimony; conductive polymers, such as polyacetylene, polyaniline and polythiophene; thermal decomposition products of organic substances (for example, carbon modified with carboxylic acid), and ionic conductive materials such as polystyrene sulfonate, and the like. Carbon is preferably used as the conductive substance.

The content of the conductive substance is preferably adjusted to such an amount as to set the volume specific resistance of the base member 175 within a range that will be described later.

The thickness of the base member 175 is not particularly limited as long as the object of the present invention can be achieved, and for example, it is preferably set to 50 to 150 μm.

The volume specific resistance of the base member 175 is normally set to 1×10⁶ Ωcm to 1×10¹² Ωcm, and preferably to 1×10⁶ Ωcm to 1×10¹¹ Ωcm.

The volume specific resistance of the base member is a value measured according to JIS-K6911, and given as an average value of values measured at arbitrary 10 points by Hirester MCP-HT450 (made by Mitsubishi Chemical Analytech Co., Ltd.).

The glass transition temperature (Tg) of the base member 175 is not particularly limited as long as the object of the present invention can be achieved, and for example, it is set to 80 to 90° C., and particularly preferably set to 85 to 88° C.

The glass transition temperature of the base member is given as a value measured by a DSC (made by Seiko Instruments Inc.).

The base member 175 is easily produced to have a seamless belt shape by using processes in which PPS, polyamide and desired materials are mixed, and subjected to a melt-kneading process, and then extruded through an annular metal mold die and cooled.

Prior to the formation of the inorganic layer, the surface of the base member on which the inorganic layer 176 is to be formed may be pretreated by using a known method, such as plasma, flame or ultraviolet-ray irradiation.

The inorganic layer 176 is allowed to have a semi-conductive property, and more specifically prepared as an inorganic layer having a volume specific resistance in the range from 1×10⁷ Ωcm to 1×10¹³ Ωcm, and more preferably from 1×10⁹ Ωcm to 1×10¹³ Ωcm. When the volume specific resistance of the inorganic layer is too high, it is not possible to discharge accumulated electric charge to cause the belt to be in a charged state, resulting in image noise, and consequently failing to sufficiently maintain superior transferring characteristic and cleaning characteristic. When the volume specific resistance is too low, an electrical current is allowed to flow through the inorganic layer upon charging the belt, resulting in image noise.

The volume specific resistance of the inorganic layer 176 is a value measured according to JIS-K6911, and given as an average value of values measured at arbitrary 10 points by Hirester MCP-HT450 (made by Mitsubishi Chemical Analytech Co., Ltd.).

The thickness of the inorganic layer 176 is not particularly limited as long as the object of the present invention can be achieved, and for example, it is normally set to 10 to 300 nm, and preferably to 10 to 170 nm from the viewpoint of conductivity of the inorganic layer.

A material to be used for composing the inorganic layer 176 is a metal oxide, and contains at least one kind of oxide selected from the group consisting of silicon oxide, aluminum oxide, titanium oxide, zinc oxide, zirconium oxide and tin oxide. A preferable material for forming the inorganic layer is silicon oxide, aluminum oxide or a mixture of these.

When a predetermined inorganic layer is formed on the base member 175 containing PPS and polyamide by using a plasma CVD method, the inorganic layer 176 is allowed to have a semi-conductive property. By using a vacuum vapor deposition method, a sputtering method, a thermal CVD method or a sol-gel method, it is not possible to form an inorganic layer having a sufficient conductive property. The mechanism by which the semi-conductive property is given to the inorganic layer by carrying out the plasma CVD method on the base member has not been specifically clarified; however, the mechanism is presumably explained as follows. In the case when the plasma CVD method is carried out on the base member containing PPS and polyamide, while a predetermined inorganic layer is formed on the surface of the base member, polyamide in the base member is lixiviated by the plasma onto the base member surface to be decomposed. For this reason, the polyamide decomposition product is contained in the inorganic layer, in particular, at a portion in the inorganic layer to be brought into contact with the base member, with the result that the inorganic layer is allowed to have a semi-conductive property.

The plasma CVD method (Plasma Chemical Vapor Deposition Method) is a method in which a mixed gas containing at least a discharge gas and a material gas for a desired inorganic layer is formed into plasma so that a film corresponding to the material gas is deposited and formed, and this method may be carried out under the atmospheric pressure or a reduced pressure. In the present invention, from the viewpoints of further improving the transferring characteristic and cleaning characteristic of the intermediate transfer belt, an atmospheric pressure plasma CVD method of carrying out the plasma CVD method under the atmospheric pressure or the vicinity thereof is preferably adopted. The reason for this is because, when the method is carried out under a reduced pressure, polyamide lixiviated onto the base member surface is partially evaporated so that the volume specific resistance of the inorganic layer becomes greater in comparison with the case in which the process is carried out under the atmospheric pressure or the vicinity thereof.

The atmospheric pressure or the vicinity thereof corresponds to about 20 kPa to 110 kPa, and in order to obtain desired effects described in the present invention, it is preferably set in the range from 93 kPa to 104 kPa.

The film-forming temperature (surface temperature of the base member) is set to 50° C. or more to less than the glass transition temperature of the base member. When the film-forming temperature is too high, the semi-conductive property possessed by the inorganic layer is lowered.

As the discharge gas, for example, an argon gas, a nitrogen gas, an oxygen gas, a hydrogen gas or the like may be used.

As the material gas for the silicon oxide layer, for example, tetraethoxy silane (TEOS), tetramethoxy silane (TMOS), tetrachloro silane, or the like may be used.

As the material gas for the aluminum oxide, for example, aluminum chloride, trimethyl aluminum, triethoxy aluminum, trimethoxy aluminum, or the like may be used.

As the material gas for the titanium oxide layer, for example, titanium chloride, tetramethoxy titanium, tetraethoxy titanium, or the like may be used.

As the material gas for the zinc oxide layer, for example, diethoxy zinc, zinc chloride, or the like may be used.

As the material gas for the tin oxide layer, for example, tetraethoxy tin, tin chloride, or the like may be used.

By exemplifying a system in which the inorganic layer of the intermediate transfer member is formed by the atmospheric pressure plasma CVD method, the following description will explain the device and method thereof.

FIG. 3 is an explanatory drawing of a manufacturing device used for manufacturing an intermediate transfer member.

A manufacturing device 2 for the intermediate transfer member (using a direct system in which a discharge space and a thin-film deposition area are composed of virtually the same portion, and the base member is exposed to plasma so that a layer is deposited and formed), which forms an inorganic layer on a base member, is constituted by a roll electrode 20 that rotates in the arrow direction, with the base member 175 of the intermediate transfer member having an endless belt shape being passed thereon, a driven roller 201, and an atmospheric pressure plasma CVD device 3 that is a film-forming device used for forming the inorganic layer on the surface of the base member.

The atmospheric pressure plasma CVD device 3 is provided with at least one set of a fixed electrode 21 disposed along the periphery of the roll electrode 20: a discharge space 23 that corresponds to an area opposed to the fixed electrode and the roll electrode 20, where a discharge is carried out, a mixed gas supply device 24 that generates a mixed gas G containing at least a material gas and a discharge gas and supplies the mixed gas G to the discharge space 23, a discharge container 29 that alleviates an air flow into the discharge space 23 or the like, a first power supply 25 connected to the fixed electrode 21, a second power supply 26 connected to the roll electrode 20, and an exhaust unit 28 that discharges an exhaust gas G′ that has been used.

In this structure, the second power supply 26 may be connected to the fixed electrode 21, and the first power supply 25 may be connected to the roll electrode 20.

The mixed gas supply device 24 supplies a mixed gas formed by mixing a material gas used for forming a predetermined inorganic layer and a discharge gas to the discharge space 23.

The driven roller 201 is pressed in the arrow direction by a tension applying means 202 so that a predetermined tension is applied to the base member 175. The tension applying means 202 releases application of the tension, for example, when the base member 175 is exchanged, so that the base member 175 can be easily exchanged.

The first power supply 25 outputs a voltage having a frequency ω1 and the second power supply 26 outputs a voltage having a frequency ω2 that is higher than the frequency ω1, so that by these voltages, an electric field V in which the frequency ω1 and the frequency ω2 are superposed is generated in the discharge space 23. The mixed gas G is formed into plasma by the electric field V so that a film (inorganic layer) corresponding to the material gas contained in the mixed gas G is deposited on the surface of the base member 175.

As another mode, among the roll electrode 20 and the fixed electrode 21, one electrode may be grounded, while the other electrode may be connected to a power supply. In this case, the second power supply is preferably used as the power supply so as to carry out a precise film-forming process, and in particular, this structure is preferably used when a rare gas, such as argon, is used as the discharge gas.

Among a plurality of fixed electrodes, those fixed electrodes located on the downstream side in the rotation direction of the roll electrode and the inorganic layers may be deposited in a manner so as to accumulate one after another by the mixed gas supply device so that the thickness of the inorganic layer may be adjusted.

In order to improve the adhesive property between the inorganic layer and the base member, a gas supply device for supplying a gas, such as argon, oxygen or hydrogen, and a fixed electrode are formed on the upstream of the fixed electrode for forming an inorganic layer and the mixed gas supply device so that a plasma treatment may be carried out to activate a surface 171a of the base member.

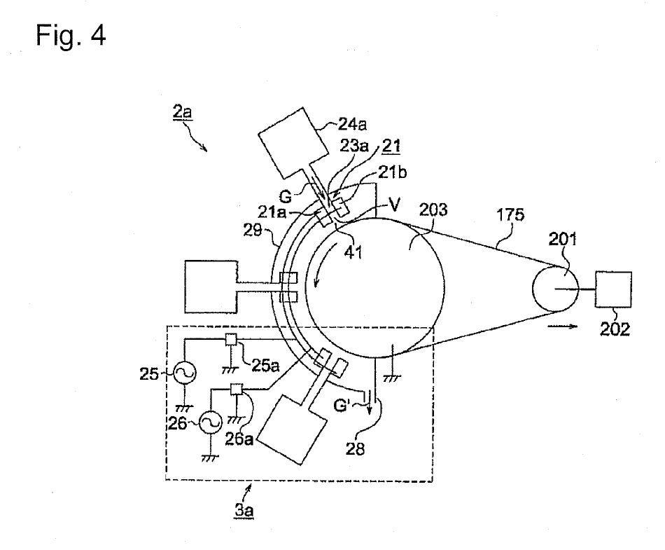

FIG. 4 is an explanatory drawing of a second manufacturing device used for manufacturing an intermediate transfer member.

A second manufacturing device 2a for the intermediate transfer member (using a plasma jet system in which a discharge space and a thin-film deposition area are prepared as different areas, and plasma is injected onto the base member so that the layer is deposited and formed), which forms an inorganic layer on a base member, is constituted by a roll 203 that rotates in the arrow direction, with the base member 175 of the intermediate transfer member having an endless belt shape being passed thereon, the driven roller 201, and an atmospheric pressure plasma CVD device 3a that is a film-forming device used for forming the inorganic layer on the surface of the base member.

The atmospheric pressure plasma CVD device 3a is different from the aforementioned atmospheric pressure plasma CVD device 3 in the connection of the power supply to the electrode and in the portion relating to the supply of the mixed gas and the deposition of the film, and the following description will explain those different portions.

The atmospheric pressure plasma CVD device 3a is provided with at least a pair of fixed electrodes 21 disposed along the periphery of the roll 203, a discharge space 23a that corresponds to an area opposed to one of the fixed electrodes 21a and the other fixed electrode 21b, where a discharge is carried out, a mixed gas supply device 24a that generates a mixed gas G containing at least a material gas and a discharge gas and supplies the mixed gas G to the discharge space 23a, a discharge container 29 that alleviates an air flow into the discharge space 23a or the like, a first power supply 25 connected to one of the fixed electrodes 21a, a second power supply 26 connected to the other fixed electrode 21b and an exhaust unit 28 that discharges an exhaust gas G′ that has been used.

In this structure, the second power supply 26 may be connected to the fixed electrode 21a, and the first power supply 25 may be connected to the fixed electrode 21b.

The mixed gas supply device 24a supplies a mixed gas formed by mixing a material gas used for forming a predetermined inorganic layer and a discharge gas to the discharge space 23a.

The first power supply 25 outputs a voltage having a frequency ω1 and the second power supply 26 outputs a voltage having a frequency ω2 that is higher than the frequency ω1, so that by these voltages, an electric field V in which the frequency ω1 and the frequency ω2 are superposed is generated. The mixed gas G is formed into plasma (excited) by the electric field V, and the mixed gas formed into plasma (excited) is injected onto the surface of the base member 175 so that a film (inorganic layer) corresponding to the material gas contained in the injected mixed gas that has been formed into plasma (excited) is deposited and formed on the surface of the base member 175.

As another mode, one of the paired fixed electrodes (21a, 21b) may be grounded, while the other fixed electrode may be connected to the power supply. In this case, the second power supply is preferably used as the power supply so as to carry out a precise film-forming process, and in particular, this structure is preferably used when a rare gas, such as argon, is used as the discharge gas.

The intermediate transfer member may be a rotation drum having a cylindrical shape, and in FIGS. 3 and 4, the roll electrode 20 and the base member 175 in FIG. 3 may be substituted by cylindrical base members, and the roll 203 and the base member 175 in FIG. 4 may be substituted by cylindrical base members.

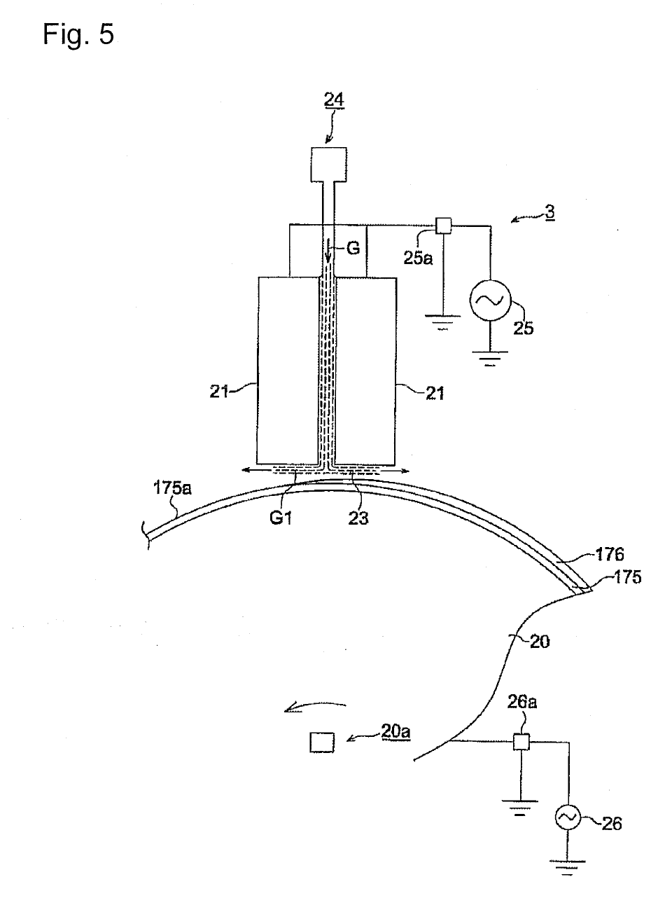

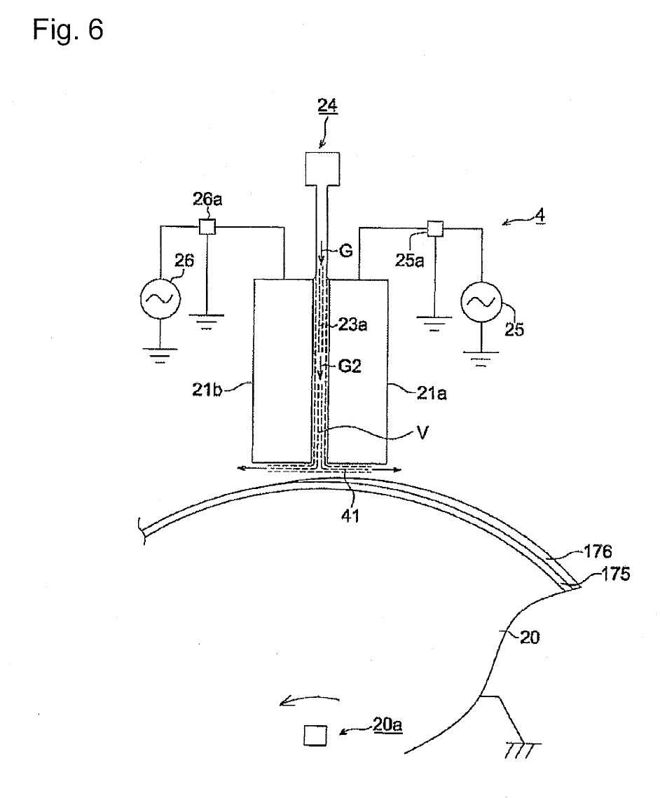

The following description will explain various modes of the atmospheric pressure plasma CVD devices used for forming an inorganic layer on the base member. The following FIGS. 5 and 6 correspond to portions mainly formed by extracting the broken-line portions in FIGS. 3 and 4.

FIG. 5 is an explanatory drawing that shows a first manufacturing device for manufacturing an intermediate transfer member by using plasma.

Referring to FIG. 5, the following description will explain one example of a first embodiment of an atmospheric pressure plasma CVD device that is preferably used for forming an inorganic layer.

As described earlier, the first atmospheric pressure plasma CVD device 3 is provided with the mixed gas-supply device 24, the fixed electrode 21, the first power supply 25, the first filter 25a, the roll electrode 20, a driving means 20a that drives the roll electrode to rotate in the arrow direction, the second power supply 26 and a second filter 26a so that plasma discharge is exerted in the discharge space 23 as described earlier, and the mixed gas G formed by mixing a material gas and a discharge gas is excited so that a base member surface 175a is exposed to the mixed gas G1 thus excited; thus, an inorganic layer is deposited and formed on the surface thereof. That is, the discharge space also serves as a thin-film forming area.

In this case, the first high frequency voltage with the frequency ω1 is applied to the fixed electrode 21 from the first power supply 25, and a high frequency voltage with the frequency ω2 is applied to the roll electrode 20 from the second power supply 26; thus, an electric field in which the frequency ω1 with an electric field intensity V1 and the frequency ω2 with an electric field intensity V2 are superposed, is generated between the fixed electrode 21 and the roll electrode 20 so that a current I1 is allowed to flow through the fixed electrode 21, while a current I2 is allowed to flow through the roll electrode 20, so that plasma is generated between the electrodes.

In this case, the relationship between the frequency ω1 and the frequency ω2 and the relationship between the electric field intensity V1 and the electric field intensity V2, as well as an electric-field high-intensity IV that starts a discharging process of a discharge gas, are set to satisfy ω1<ω2 and V1≧IV>V2 or V1>IV≧V2, with the output density of the second high-frequency electric field being set to 1 W/cm² or more.

Since the electric-field high-intensity IV that starts a discharging process of a nitrogen gas is set to 3.7 kV/rum, at least the electric field intensity V1 applied from the first power supply 25 is preferably set to 3.7 kV/mm or more, and the electric field intensity V2 to be applied from a second high-frequency power supply 26 is preferably set to 3.7 kV/mm or less.

As the first power supply 25 (high-frequency power supply) applicable to the first atmospheric pressure plasma CVD device 3, the following commercial products are proposed, and any of these may be used.

| Applied Power | | | | |
|---|---|---|---|---|
| Supply Symbol | Maker | Frequency | | Product Name |
| A1 | Sinfonia | 3 | kHz | SPG3-4500 |
| | Technology | | | |
| | Co., Ltd. | | | |
| A2 | Sinfonia | 5 | kHz | SPG5-4500 |
| | Technology | | | |
| | Co., Ltd. | | | |
| A3 | Kasuga | 15 | kHz | AGI-023 |
| | Electric | | | |
| | Works, Ltd. | | | |
| A4 | Sinfonia | 50 | kHz | SPG50-4500 |
| | Technology | | | |
| | Co., Ltd. | | | |
| A5 | Haiden | 100 | kHz* | PHF-6k |
| | Laboratory | | | |
| A6 | Pearl Kogyo | 200 | kHz | CF-2000-200k |
| | Co., Ltd. | | | |
| A7 | Pearl Kogyo | 400 | kHz | CF-2000-400k |
| | Co., Ltd. | | | |

As the second power supply 26 (high-frequency power supply), the following commercial products are proposed, and any of these may be preferably used.

| Applied Power | | | | |
|---|---|---|---|---|
| Supply Symbol | Maker | Frequency | | Product Name |
| B1 | Peal Kogyo | 800 | kHz | CF-2000-800k |
| | Co., Ltd. | | | |
| B2 | Peal Kogyo | 2 | MHz | CF-2000-2M |
| | Co., Ltd. | | | |
| B3 | Peal Kogyo | 13.56 | MHz | CF-5000-13M |
| | Co., Ltd. | | | |
| B4 | Peal Kogyo | 27 | MHz | CF-2000-27M |
| | Co., Ltd. | | | |
| B5 | Peal Kogyo | 150 | MHz | CF-2000-150M |
| | Co., Ltd. | | | |

Among the above-mentioned power supplies, the power supply indicated by symbol* is an impulse high-frequency power supply (100 kHz in continuous mode) made by Haiden Laboratory. Those power supplies other than this are high-frequency power supplies which can apply only a continuous sine wave.

In the present invention, as the power to be applied between the opposed electrodes from the first and second power supplies, a power (output density) of 1 W/cm² or more is supplied to the fixed electrode 21 so that a discharge gas is excited to generate plasma so that a thin film is formed. The upper limit value of the power to be supplied to the fixed electrode 21 is preferably set to 50 W/cm², and more preferably to 20 W/cm². The lower limit value thereof is preferably set to 1.2 W/cm². The discharge area (cm²) refers to the area of a range in which discharge is exerted by the electrodes.

By supplying a power (output density) of 1 W/cm² or more also to the roll electrode 20, it is possible to improve the output density, with the uniformity of the high-frequency electric field being maintained. Thus, it becomes possible to generate uniform plasma with higher density, and also to simultaneously further improve the film-forming rate and the film quality. Preferably, the power is set to 5 W/cm² or more. The upper limit value of the power to be supplied to the roll electrode 20 is preferably set to 50 W/cm².

The waveform of the high-frequency electric field is not particularly limited. A continuous oscillation mode having a continuous sine wave shape, referred to as a continuous mode, and an intermittent oscillation mode that carries out ON/OFF intermittently and is referred to as a pulse mode, are proposed, and either of these may be adopted; however, as the high frequency wave to be supplied to at least the roll electrode 20, the continuous sine wave is preferably used because a finer film with better quality can be obtained.

A first filter 25a is installed between the fixed electrode 21 and the first power supply 25 so that an electric current from the first power supply 25 to the fixed electrode 21 is allowed to pass more easily, while an electric current from the second power supply 26 is grounded so that the electric current from the second power supply 26 to the first power supply 25 is made difficult to pass therethrough. A second filter 26a is installed between the roll electrode 20 and the second power supply 26 so that an electric current from the second power supply 26 to the roll electrode 20 is allowed to pass more easily, while an electric current from the first power supply 21 is grounded so that the electric current from the first power supply 25 to the second power supply 26 is made difficult to pass therethrough.

As the electrode, those electrodes that can maintain a uniform, stable discharge state by applying the above-mentioned high electric field thereto are preferably adopted, and with respect to the fixed electrode 21 and the roll electrode 20, at least the electrode surface of one of these electrodes is coated with the following dielectric material so as to withstand discharge caused by the strong electric field.

With respect to the relationship between the electrodes and the power supplies in the above explanation, the second power supply 26 may be connected to the fixed electrode 21, and the first power supply 25 may be connected to the roll electrode 20.

As another mode, an arrangement may be used in which one of the electrodes is grounded, with the second power supply being used as the power supply to which the other electrode is connected so that a precise thin-film forming process can be desirably carried out, and in particular, this structure is preferably used when a rare gas, such as argon, is used as the discharge gas.

FIG. 6 is an explanatory drawing of a second manufacturing device for manufacturing an intermediate transfer member by using plasma.

Referring to FIG. 6, the following description will discuss one example of a second embodiment of the atmospheric pressure plasma device used for forming an inorganic layer.

The atmospheric pressure plasma device 4 has the same structure as that of the atmospheric pressure plasma CVD device 3 of FIG. 5 except that it is provided with a pair of fixed electrodes 21a and 21b, and that a first filter 25a and a first power supply 25 are connected to the fixed electrode 21a, while a second filter 26a and a second power supply 26 are connected to the fixed electrode 21b, with a roll electrode 20 being grounded.

The following description will explain functions thereof: The first high frequency voltage with a frequency ω1 is applied to the fixed electrode 21a from the first power supply 25, with a high frequency voltage with a frequency ω2 being applied to the fixed electrode 21b from the second power supply 26, so that an electric field in which the frequency ω1 with an electric field intensity V1 and the frequency ω2 with an electric field intensity V2 are superposed, is generated between the fixed electrodes 21a and 21b so that a current I1 is allowed to flow through the fixed electrode 21a, while a current I2 is allowed to flow through the fixed electrode 21b, so that plasma is generated between the electrodes.

Thus, a mixed gas G2, formed into plasma, is injected onto the surface of the base member 175 in a thin film-forming area 41 to deposit and form an inorganic layer 176 thereon.

One of the electrodes may be grounded, and the second power supply is preferably used as the power supply to be connected to the other electrode so as to carry out a fine film-forming process, and in particular, this structure is preferably used when a rare gas, such as argon, is used as the discharge gas.

A system in which plasma is generated in an electric field formed by superposing different frequencies and voltages from two power supplies, such as the first atmospheric pressure plasma CVD device 3 or the atmospheric pressure plasma device 4, is preferably used in the case when nitrogen is used as a discharge gas, and by applying a high voltage by the first power supply, with a high frequency being applied by the second power supply, it is possible to start discharge and also to continue the discharge in a stable manner.

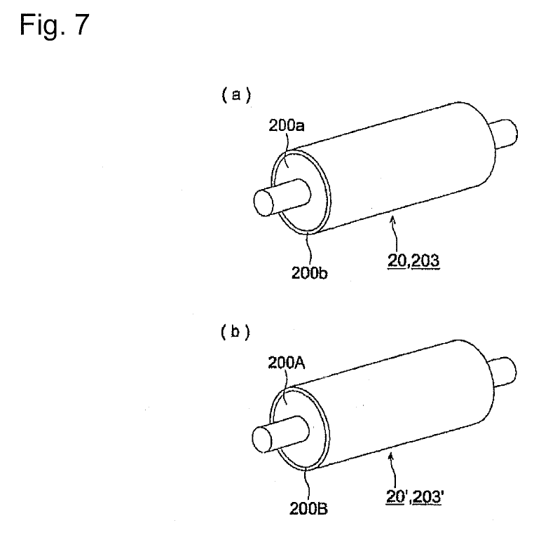

FIG. 7 is a schematic drawing that shows one example of the roll electrode.

The following description will explain the structure of the roll electrode 20 (203). In FIG. 7(a), the roll electrode 20 is formed by combined processes in which, after a conductive base material 200a (hereinafter, referred to also as an “electrode base material”) made of a metal or the like, has been flame coated with a ceramic material and pore-sealed, the resulting ceramic-coated dielectric member 200b (hereinafter, may be referred to simply as a “dielectric member”) is coated with an inorganic material. As the ceramic material used for the flame coating process, alumina, silicon nitride or the like is preferably used, and among these, alumina is more preferably used because of its easiness in processing.

As shown in FIG. 7(b), a roll electrode 20′ may be formed by combined processes in which a conductive base material 200A, such as a metal, is coated with a lining-treated dielectric member 200B on which an inorganic material has been formed by using a lining process. As the lining material, for example, silicate-based glass, borate-based glass, phosphate-based glass, germanate-based glass, tellurite-based glass, aluminate-based glass and vanadate-based glass are preferably used, and among these, borate-based glass is more preferably used because of its easiness in processing.

As the conductive base materials 200a and 200A, such as a metal, for example, metals such as silver, platinum, stainless steel, aluminum and iron are used, and among these, stainless steel is more preferably used from the viewpoint of processing.

In the present embodiment, as the base materials 200a and 200A of the roll electrode, a stainless jacket roll base material having a cooling means by cooling water is used (not shown).

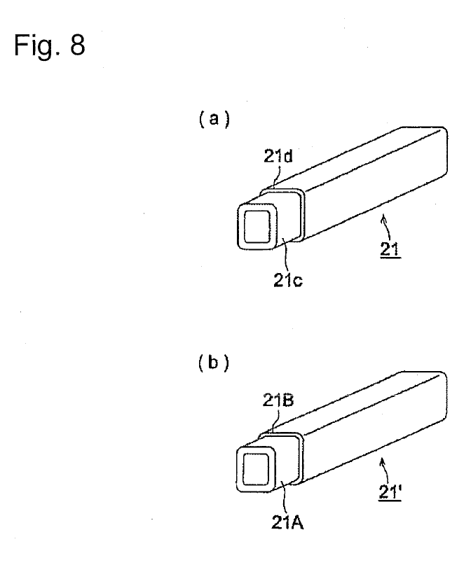

FIG. 8 is a schematic drawing that shows one example of a fixed electrode.

In FIG. 8(a), in the same manner as in the roll electrode 20 described earlier, a fixed electrode 21 having a rectangular pillar shape or a rectangular tube shape is formed by combined processes in which, after a conductive base material 21c made of a metal or the like, has been flame coated with a ceramic material and pore-sealed, the resulting ceramic-coated dielectric member 21d is coated with an inorganic material. As shown in FIG. 8(b), a fixed electrode 21′ having a rectangular pillar shape or a rectangular tube shape is formed by combined processes in which a conductive base material 21A, such as a metal, is coated with a lining-treated dielectric member 21B on which an inorganic material has been formed by using a lining process.

Among the processes of the manufacturing method of the intermediate transfer member, referring to FIGS. 3 and 5 as well as FIGS. 4 and 6, the following description will explain film-forming processes in which the inorganic layer 176 is deposited and formed on the base member 175.

In FIGS. 3 and 5, after the base member 175 has been extended and passed over the roll electrode 20 and the driven roller 201, a predetermined tension is applied to the base member 175 by the tension applying means 202, and the roll electrode 20 is driven to rotate at a predetermined number of rotations.

The above-mentioned mixed gas G is generated by the mixed gas supply device 24, and discharged into the discharge space 23.

A voltage having a frequency ω1 is outputted from the first power supply 25, and applied to the fixed electrode 21, and a voltage having a frequency ω2 is outputted from the second power supply 26, and applied to the roll electrode 20, so that an electric field V where the frequency ω1 and the frequency ω2 are superposed is generated in the discharge space 23 by these voltages.

The mixed gas G discharged into the discharge space 23 is excited by the electric field V to be formed into a plasma state. Then, the base member surface is exposed to the mixed gas G in the plasma state so that the inorganic layer 176 (FIG. 5) is formed on the base member 175 by the material gas in the mixed gas G.

In FIGS. 4 and 6, a voltage having a frequency ω1 is outputted from the first power supply 25, and applied to the fixed electrode 21a, and a voltage having a frequency ω2 is outputted from the second power supply 26, and applied to the fixed electrode 21b, so that an electric field V in which the frequency ω1 and the frequency ω2 are superposed is generated in the discharge space 23a by these voltages.

The mixed gas G passing through the discharge space 23a is excited by the electric field V to be formed into a plasma state, and a mixed gas G2 (FIG. 6) formed into the plasma state is discharged into the thin-film forming area 41 so that the base member surface is exposed to the gas in the thin film-forming area 41. The inorganic layer 176 is formed on the base member 175 by the material gas in the mixed gas G2.

### Examples

### Example 1

PPS (polyphenylene sulfide: made by Toray Industries, Inc.) (94 parts by weight), 6-Nylon (made by Toray Industries, Inc.) (6 parts by weight) and acidic carbon (made by Degussa) (9 parts by weight) were mixed, and the mixture was kneaded by a continuous twin screw kneader (KTX30: made by Kobe Steel, Ltd.) at 290° C. at 300 rpm. The kneaded matter was extrusion-molded through an annular metal mold die so that a base member (thickness: 110 μm) having a seamless belt shape was obtained. The volume specific resistance of this base member was measured at arbitrary 10 points, and the average value of these was found.

An SiO₂ layer was formed on the surface of the base member having a seamless belt shape by using an atmospheric pressure plasma CVD method. Specifically, by using a plasma CVD device shown in FIG. 5, the layer was formed under the following conditions. The volume specific resistance of this inorganic layer was measured.
Discharge gas=Oxygen gas
Discharge gas flow rate=10 slm (standard-liter/min.)
Material gas=TEOS
Material gas flow rate=2 slm (standard-liter/min.)
Applied power=1.6 KW

### Examples 2 to 9/Comparative Examples 1 to 6

The same method as that of example 1 was carried out except that the composition and thickness of the base member were changed as described in Table 1 and that the forming method and forming conditions of the inorganic layer were changed as described in Table 1 so that intermediate transfer belts were produced.

In Comparative Example 3, as the inorganic layer, an SiO₂ layer was formed on the base member by vacuum vapor deposition using a known method.

In Comparative Example 4, the inorganic layer was formed by a sputtering method by using a magnetron sputtering device as the sputtering device.
Supplied gas Argon gas: 5 cm³/m, pressure: 0.67 Pa
Supplied power 1.2 KW
Target material=Silicon

In Comparative Example 5, as the inorganic layer, an SiO₂ layer was formed on the base member by a coating process using a known method (coating method 1). Specifically, tetraethoxy silane (580 g) and ethanol (1144 g) were mixed, and to this was added an aqueous solution of citric acid (prepared by dissolving citric acid monohydrate (5.4 g) in water (272 g)), and this was then stirred for one hour at room temperature (25° C.) so that a tetraethoxy silane-hydrolyzed matter A was prepared.

By using the following composition with this hydrolyzed matter A added thereto, a coating process was carried out with a wire bar to form a film having a film thickness (wet film thickness) of 1 μm, and this was dried at 80° C. for 2 minutes.

| | |
|---|---|
| Propylene glycol monomethylether | 303 parts by mass |
| Isopropyl alcohol | 305 parts by mass |
| Tetraethoxy silane-hydrolyzed matter A | 139 parts by mass |
| γ-methacryloxypropyl trimethoxysilane | 1.6 parts by mass |
| (KBM503 made by Shin-Etsu Chemical Co., Ltd.) | |

In Comparative Example 6, as the inorganic layer, an SiO₂ layer was formed on the base member by a coating process (coating method 2). Specifically, by using the hydrolyzed matter A in the same manner as in coating method 1 and the following composition, a coating process was carried out to form a film having a film thickness (wet film thickness) of 1.8 μm, and this was dried at 80° C. for 2 minutes.

| | |
|---|---|
| Propylene glycol monomethylether | 303 parts by mass |
| Isopropyl alcohol | 305 parts by mass |
| Tetraethoxy silane-hydrolyzed matter A | 139 parts by mass |

TABLE 1

| | Base member | | | | | | |
|---|---|---|---|---|---|---|---|
| | | | | Volume specific | | Inorganic layer | |
| | PPS | Polyamide | Thickness | resistance | Tg | Forming | |
| | (parts by weight) | (parts by weight) | (μm) | (Ω cm) | (° C.) | method | Pressure |
| Example 1 | 94 | 6 | 110 | 3 × 10⁹ | 87 | A | 1 |
| Example 2 | 92 | 8 | 110 | 8 × 10⁹ | 87 | A | 1 |
| Example 3 | 94 | 6 | 110 | 3 × 10⁹ | 87 | A | 1 |
| Example 4 | 94 | 6 | 110 | 3 × 10⁹ | 87 | A | 1 |
| Example 5 | 92 | 8 | 105 | 6 × 10⁹ | 87 | A | 1 |
| Example 6 | 85 | 15 | 110 | 6 × 10⁹ | 87 | A | 1 |
| Example 7 | 90 | 10 | 110 | 8 × 10⁹ | 87 | A | 1 |
| Example 8 | 94 | 6 | 130 | 3 × 10⁹ | 87 | B | 0.1 |
| Example 9 | 94 | 6 | 120 | 3 × 10⁹ | 87 | A | 1 |
| Comparative | PI; 100 | 0 | 105 | 9 × 10⁹ | ** | — | — |
| Example 1 * | | | | | | | |
| Comparative | 100 | 0 | 120 | 8 × 10⁸ | 90 | A | 1 |
| Example 2 | | | | | | | |
| Comparative | 94 | 6 | 110 | 3 × 10⁹ | 87 | C | 0.1 |
| Example 3 | | | | | | | |
| Comparative | 92 | 8 | 110 | 5 × 10⁹ | 87 | D | 0.1 |
| Example 4 | | | | | | | |
| Comparative | 92 | 8 | 110 | 5 × 10⁹ | 87 | E | 1 |
| Example 5 | | | | | | | |
| Comparative | 92 | 8 | 110 | 5 × 10⁹ | 87 | F | 1 |
| Example 6 | | | | | | | |

| | Inorganic layer | | | | | | |
|---|---|---|---|---|---|---|---|
| | Film-forming | | | | Volume specific | Evaluation | |
| | temperature | Material | | Thickness | resistance | Transferring | Cleaning |
| | (° C.) | gas | Kind | (μm) | (Ω cm) | characteristic | characteristic |
| Example 1 | 70 | TEOS | SiO₂ | 20 | 3 × 10⁹ | ⊙ | ⊙ |
| Example 2 | 70 | AlCl₃ | Al₂O₃ | 20 | 8 × 10⁹ | ⊙ | ⊙ |
| Example 3 | 70 | Zn(OC₂H₅)₂ | ZₙO | 20 | 3 × 10⁹ | ⊙ | ⊙ |
| Example 4 | 70 | Sn(OC₂H₅)₄ | SₙO₂ | 20 | 3 × 10⁹ | ⊙ | ⊙ |
| Example 5 | 70 | TiCl₄ | TiO₂ | 20 | 5 × 10⁹ | ⊙ | ⊙ |
| Example 6 | 70 | TEOS | SiO₂ | 20 | 6 × 10⁹ | ◯ | ◯ |
| Example 7 | 70 | TEOS | SiO₂ | 120 | 8 × 10⁹ | ◯ | ◯ |
| Example 8 | 70 | TEOS | SiO₂ | 40 | 3 × 10⁹ | Δ | Δ |
| Example 9 | 80 | TEOS | SiO₂ | 40 | 3 × 10⁹ | Δ | Δ |
| Comparative | — | — | None | — | — | ⊙ | X |
| Example 1 * | | | | | | | |
| Comparative | 70 | TEOS | SiO₂ | 20 | Not | X | X |
| Example 2 | | | | | measurable | | |
| Comparative | 24 | TEOS | SiO₂ | 150 | Not | X | X |
| Example 3 | | | | | measurable | | |
| Comparative | 24 | TEOS | SiO₂ | 150 | Not | X | X |
| Example 4 | | | | | measurable | | |
| Comparative | 24 | TEOS | SiO₂ | 150 | Not | X | X |
| Example 5 | | | | | measurable | | |
| Comparative | 24 | TEOS | SiO₂ | 150 | Not | X | X |
| Example 6 | | | | | measurable | | |

PI: Polyimide
A: Atmospheric pressure plasma CVD method, B: Plasma CVD method (reduced pressure), C: Vacuum vapor deposition method, D: Sputtering method, E: Coating method 1, F: Coating method 2
* The base member of Comparative Example 1 was produced by using a thermal hardening method.
** No distinct Tg was observed with respect to the base member of Comparative Example 1.

Evaluation

Each of the manufactured intermediate transfer belts was loaded into a printer, and evaluated under standard conditions of the printer.

Transferring Characteristic

Image-forming processes were carried out on a predetermined number of sheets, and images, formed on the sheets during the processes, were visually observed, and the transferring characteristic was evaluated by confirming a state of hollow defects. In the case when no hollow defect was observed until completion of image-forming processes of 100,000 sheets, this state was evaluated as superior (⊙); in the case when no hollow defect was observed until completion of image-forming processes of 50,000 sheets, this state was evaluated as good (◯); in the case when some hollow defects were observed upon completion of image-forming processes of 50,000 sheets, this state was evaluated as acceptable (Δ) (no problems are raised in practical use), and in the case when hollow defects were observed in image-forming processes of less than 50,000 sheets, this state was evaluated as bad (×) (problems are raised in practical use).

Cleaning Characteristic

Image-forming processes were carried out on a predetermined number of sheets, and the intermediate transfer belt was visually observed during the processes, and the cleaning characteristic was evaluated by confirming a toner-adhering state. In the case when no toner adhesion was observed until completion of image-forming processes of 200,000 sheets, this state was evaluated as superior (⊙); in the case when no toner adhesion was observed until completion of image-forming processes of 150,000 sheets, this state was evaluated as good (◯); in the case when some toner adhesion was observed upon completion of image-forming processes of 100,000 sheets, this state was evaluated as acceptable (Δ) (no problems are raised in practical use), and in the case when toner adhesion was observed in image-forming processes of less than 50,000 sheets, this state was evaluated as bad (×) (problems are raised in practical use).

### Effects of the Invention

In accordance with the present invention, by forming an inorganic layer on a base member containing polyphenylene sulfide and polyamide by the use of a plasma CVD method, preferably an atmospheric pressure plasma CVD method, the inorganic layer is allowed to have a semi-conductive property.

For this reason, the intermediate transfer member of the present invention has its inorganic surface layer allowed to exert a semi-conductive property so that accumulation of electric charge can be prevented; thus, it becomes possible to maintain superior transferring characteristic and cleaning characteristic for a long period of time. Since the inorganic surface layer is formed by using the plasma CVD method, the inorganic layer exerts high adhesion to the base member, and consequently becomes less vulnerable to cracks.

In the present invention, when the inorganic layer is formed by using the atmospheric pressure plasma CVD method, it is possible to further improve the transferring characteristic and cleaning characteristic, and consequently to eliminate the necessity of having to provide a large-scale facility, such as a vacuum apparatus.

What is claimed is:

1. An intermediate transfer member comprising:
a base member containing polyphenylene sulfide and polyamide; and
a semi-conductive inorganic layer formed on the base member and having a volume specific resistance in the range from 1×10⁷ Ωcm to 1×10¹³ Ωcm.

2. The intermediate transfer member of claim 1, wherein the semi-conductive inorganic layer is formed by means of a plasma CVD method.

3. The intermediate transfer member of claim 1, wherein the semi-conductive inorganic layer is formed by means of an atmospheric pressure plasma CVD method.

4. The intermediate transfer member of claim 1, wherein the semi-conductive inorganic layer contains at least one kind of oxide selected from the group consisting of silicon oxide, aluminum oxide, titanium oxide, zinc oxide, zirconium oxide and tin oxide.

5. The intermediate transfer member of claim 1, wherein the ratio of contents of polyphenylene sulfide and polyamide in the base member is in the range from 70/30 to 95/5 in weight ratio.

6. The intermediate transfer member of claim 1, wherein the base member has a volume specific resistance in the range from 1×10⁶ Ωcm to 1×10¹² Ωcm.

7. The intermediate transfer member of claim 1, wherein the base member has a glass transition temperature in the range from 80 to 88° C.

8. An image-forming apparatus, equipped with an intermediate transfer member,
wherein the inter mediate transfer member comprises:
a base member containing polyphenylene sulfide and polyamide; and
a semi-conductive inorganic layer formed on the base member and having a volume specific resistance in the range from 1×10⁷ Ωcm to 1×10¹³ Ωcm.

9. The image-forming apparatus of claim 8, wherein the semi-conductive inorganic layer is formed by means of a plasma CVD method.

10. The image-forming apparatus of claim 8, wherein the semi-conductive inorganic layer is formed by means of an atmospheric pressure plasma CVD method.

11. The image-forming apparatus of claim 8, wherein the semi-conductive inorganic layer contains at least one kind of oxide selected from the group consisting of silicon oxide, aluminum oxide, titanium oxide, zinc oxide, zirconium oxide and tin oxide.

12. The image-forming apparatus of claim 8, wherein the ratio of contents of polyphenylene sulfide and polyamide in the base member is in the range from 70/30 to 95/5 in weight ratio.

13. The image-forming apparatus of claim 8, wherein the base member has a volume specific resistance in the range from 1×10⁶ Ωcm to 1×10¹² Ωcm.

14. The image-forming apparatus of claim 8, wherein the base member has a glass transition temperature in the range from 80 to 88° C.

15. A method for manufacturing an intermediate transfer member comprising:
forming an inorganic layer on a base member containing polyphenylene sulfide and polyamide by means of a plasma CVD method.

16. The method for manufacturing an intermediate transfer member of claim 15, wherein the inorganic layer is formed by means of an atmospheric pressure plasma CVD method.
